(19) United States
(12) Patent Application Publication
(10) Pub. No.: US 2026/0177790 A1
(43) Pub. Date: Jun. 25, 2026

(54) CAMERA MODULE AND ELECTRONIC DEVICE INCLUDING THE SAME

(71) Applicant: Samsung Electronics Co., Ltd., Suwon-si (KR)

(72) Inventor: KIWOO LEE, Suwon-si (KR)

(21) Appl. No.: 19/429,794

(22) Filed: Dec. 22, 2025

(30) Foreign Application Priority Data
Dec. 24, 2024 (KR) 10-2024-0196298

(51) Int. Cl. G02B 13/00; G03B 17/17; G03B 30/00; H04N 23/55; H04N 23/57

(52) U.S. Cl. CPC G02B 13/007; G02B 13/0045; G03B 17/17; G03B 30/00; H04N 23/55; H04N 23/57

(57) ABSTRACT

Disclosed is an electronic device according to an embodiment of the present disclosure including an image sensor, a light guide having a positive refractive power, the light guide configured to guide light to the image sensor, and a lens group located between the light guide and the image sensor. The lens group includes a first lens group including a plurality of lenses, and a second lens group including at least one lens, the first lens group is configured to move in directions crossing a light travel direction, and the second lens group does not move in the directions crossing the light travel direction.

### CROSS-REFERENCE TO RELATED APPLICATIONS

This application claims priority under 35 U.S.C. § 119 to Korean Patent Application No. 10-2024-0196298 filed on Dec. 24, 2024, in the Korean Intellectual Property Office, the disclosures of which are incorporated by reference herein in their entireties.

### BACKGROUND

Embodiments of the present disclosure described herein relate to a camera module and an electronic device including the same, and more particularly, relate to an electronic device including a foldable camera module.

A camera module may be applied to various products. According to a continuous demand for improvement of performance of camera modules embedded in electronic devices, a size of an image sensor embedded in a camera module may become larger or apertures of lenses may become larger. However, according to the trend of downsizing of electronic devices, especially mobile electronic devices, there is a limited ability to increase sizes of image sensors and apertures of the lenses.

In addition, an optical image stabilization (OIS) function and an automatic focusing function are increasingly applied to cameras due to advancement of performance of the cameras, but likewise, there is a conflict with the trend of the downsizing of electronic devices including cameras.

Specifically, hand-shake correction functions have been performed in a prism tilting method, an image sensor shift method, and/or an optical system full shift method, and the automatic focusing function has been performed in the optical system full shift method. However, the image sensor became larger due to the demand for high resolution, and the apertures of the lenses become larger due to the demand for bright F-number. Accordingly, the image sensor shift method and the optical system full shift method may not be suitable for performing hand-shake correction functions in small electronic devices. In addition, movement of the entire optical system for automatic focusing also increases according to increasing demand to gradually decrease a distance between a camera and a subject (an object for focusing in a photograph) that is automatically focused for a picture, so that the optical system full shift method is not suitable for performing the automatic focusing function in the small electronic devices.

Accordingly, researches and developments for accommodating large image sensors and lenses in the camera module while satisfying the trend of downsizing electronic devices have been made.

### SUMMARY

Embodiments of the present disclosure provide a camera module with an improved performance and an electronic device including the same.

Embodiments of the present disclosure also provide a camera module with an improved hand-shake correction function and an electronic device including the same.

Embodiments of the present disclosure also provide a camera module with an improved autofocusing performance and an electronic device including the same.

Embodiments of the present disclosure also provide a camera module with a small size and an electronic device including the same.

Embodiments of the present disclosure also provide a foldable camera module, to which a power prism is applied, and an electronic device including the same.

Embodiments of the present disclosure also provide a foldable camera module with a small lens aperture and an electronic device including the same.

An electronic device according to an embodiment of the present disclosure includes an image sensor, a light guide having a positive refractive power, the light guide configured to guide light to the image sensor, and a lens group located between the light guide and the image sensor, the lens group includes a first lens group including a plurality of lenses, and a second lens group including at least one lens, the first lens group is configured to move in directions crossing a light travel direction, and the second lens group does not move in the directions crossing the light travel direction.

An electronic device according to an embodiment of the present disclosure includes an image sensor, a reflector that guides light to the image sensor, a lens group between the reflector and the image sensor, wherein the lens group includes a first lens group including a plurality of lenses, and a second lens group including at least one lens, wherein the first lens group is configured to move in directions crossing a light travel direction, and wherein the second lens group is configured to move parallel to the light travel direction.

An electronic device according to an embodiment of the present disclosure includes an image sensor, a light guide having a positive refractive power, the light guide being configured to guide light to the image sensor, and a lens group located between the light guide and the image sensor, wherein the lens group includes a driven lens group including a plurality of lenses, and a fixed lens group including at least one lens, wherein the driven lens group is configured to move in a light travel direction, and directions crossing the light travel direction, and wherein the fixed lens group is fixed.

### BRIEF DESCRIPTION OF THE FIGURES

The above and other objects and features of the present disclosure will become apparent by describing in detail embodiments thereof with reference to the accompanying drawings.

FIG. 1 is a perspective view of a camera module according to an embodiment of the present disclosure;

FIG. 2 is a block diagram of an electronic device according to an embodiment of the present disclosure;

FIG. 3 is a perspective view of a portion of a camera module according to an embodiment of the present disclosure;

FIG. 4 is a perspective view of a first lens group according to an embodiment of the present disclosure;

FIG. 5 is a perspective view of a second lens group according to an embodiment of the present disclosure;

FIG. 6 is a cross-sectional view of a portion of a camera module according to an embodiment of the present disclosure;

FIG. 7 is a cross-sectional view of a portion of a camera module according to an embodiment of the present disclosure;

FIG. 8 is a block diagram of an electronic device according to an embodiment of the present disclosure;

FIG. 9 is a perspective view of a portion of a camera module according to an embodiment of the present disclosure;

FIG. 10 is a perspective view of a driven lens group according to an embodiment of the present disclosure;

FIG. 11 is a cross-sectional view of a portion of a camera module according to an embodiment of the present disclosure; and

FIG. 12 is a cross-sectional view of a portion of a camera module according to an embodiment of the present disclosure.

### DETAILED DESCRIPTION

Hereinafter, embodiments of the present disclosure will be described in detail with reference to the accompanying drawings.

Throughout the specification, when a component is described as “including” a particular element or group of elements, it is to be understood that the component is formed of only the element or the group of elements, or the element or group of elements may be combined with additional elements to form the component, unless the context clearly and/or explicitly describes the contrary.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

Terms such as “same,” “equal,” “planar,” “coplanar,” “parallel,” and “perpendicular,” as used herein encompass identicality or near identicality including variations that may occur, for example, due to manufacturing processes. The term “substantially” may be used herein to emphasize this meaning, unless the context or other statements indicate otherwise.

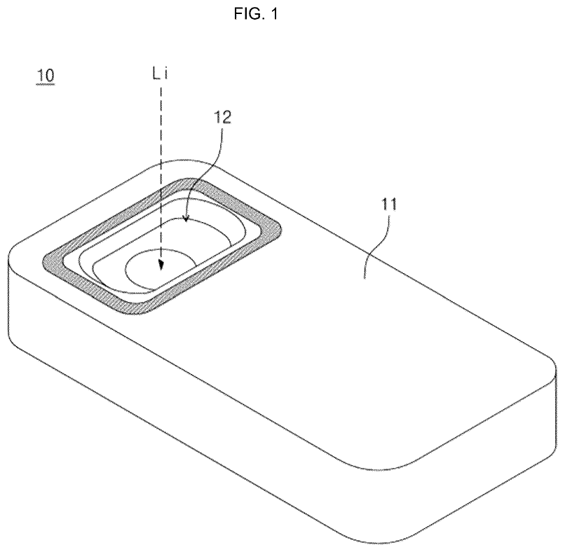

FIG. 1 is a perspective view of a camera module 10 according to an embodiment of the present disclosure.

Referring to FIG. 1, the camera module 10 may include a housing 11 having an opening 12. The opening 12 may be defined in the housing 11. The camera module 10 may receive light Li through the opening 12. The camera module 10 may be embedded in an electronic device 1. For example, the camera module 10 may be provided as a component that is embedded in the electronic device 1. For example, the camera module 10 may be applied to a wide range of electronic devices 1, such as smartphones, laptop computers, tablet PCs, wearable devices, robots, home appliances, drones, and vehicles. For example, the camera module 10 may be a camera installed in an electronic device.

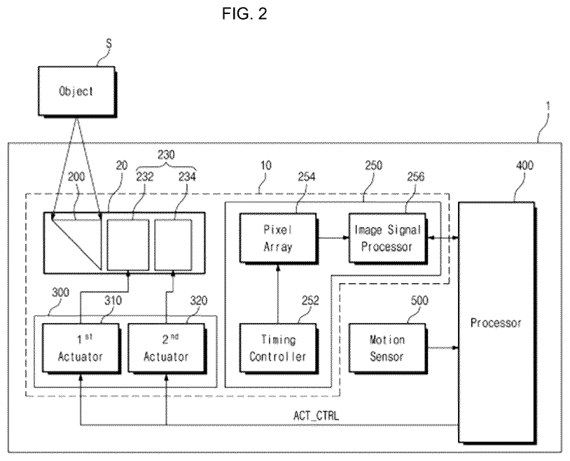

FIG. 2 is a block diagram of an electronic device 1 according to an embodiment of the present disclosure.

Referring to FIG. 2, the electronic device 1 may include a camera module 10, a processor 400, and a motion sensor 500. The camera module 10 may include an image sensor 250, a lens assembly 20, and an actuator 300.

The lens assembly 20 is a component, through which input light passes, and may include a light guide 200 and a lens group 230. The light guide 200 may receive light and guide the received light to the lens group 230. The present disclosure is not limited thereto, and the lens assembly 20 may include other components, through which the received light passes. The lens assembly 20 may be an optical system including components through which the received light passes.

For example, the lens group 230 may include a first lens group 232 and a second lens group 234. The first lens group 232 may include a plurality of lenses. The second lens group 234 may include at least one lens. For example, the first lens group 232 may perform a hand-shake correction function (e.g., a shake correction function or a camera shake correction function). In an embodiment, the first lens group 232 may perform a hand-shake correction function, and the second lens group 234 may perform automatic focusing. To this end, the first lens group 232 and the second lens group 234 may be driven independently from each other.

The image sensor 250 may generate image data and phase data based on input light. For example, light may be incident on the image sensor 250, and the image sensor 250 may generate image and phase data based on incident light that is input into the image sensor 250. The image sensor 250 may include a pixel array 254, a timing controller 252, and an image signal processor 256.

The pixel array 254 may include pixels that generate phase information. For example, any one of the pixels may be a dual photodiode pixel including a plurality of photoelectric conversion elements. In certain examples, some of the pixels may share one micro lens. The image signal processor 256 may generate phase information based on pixel signals having different phases.

The motion sensor 500 may detect shaking or movement of the camera module 10 or the electronic device 1 including the camera. For example, the motion sensor 500 may sense movements in directions that cross (e.g., are perpendicular to) a light travel direction. For example, the motion sensor 500 may include a gyro sensor and/or an accelerometer.

The actuator 300 may drive the lens group 230. For example, the actuator 300 may include a first actuator 310 that is connected to the first lens group 232 and drives the first lens group 232. The actuator 300 may include a second actuator 320 that is connected to the second lens group 234 and drives the second lens group 234.

The processor 400 may control overall operations of the electronic device 1. The processor 400 may control a movement of the lens group 230 by providing a control signal to the actuator 300. For example, the processor 400 may provide a control signal to the first actuator 310 based on vector data provided from the motion sensor 500 to the processor 400, and may control the movement of the first lens group 232. For example, the first actuator 310 may move the first lens group 232 in directions that cross and/or is perpendicular to the light travel direction based on the control signal of the processor 400. Accordingly, the electronic device 1 may perform a hand-shake correction function (e.g., a shake correction function or a camera shake correction function).

Furthermore, the processor 400 may provide a control signal to the second actuator 320 based on phase data provided from the image sensor 250 to the processor 400, and may control the movement of the second lens group 234. For example, the second actuator 320 may move the second lens group 234 in a direction that is parallel to the light travel direction based on the control signal of the processor 400. Accordingly, the electronic device 1 may perform automatic focusing.

The processor 400 may be, for example, a central processing unit (CPU), a graphic processing unit (GPU) chip, an application processor (AP), an application specific integrated circuit (ASIC), or other processing chips.

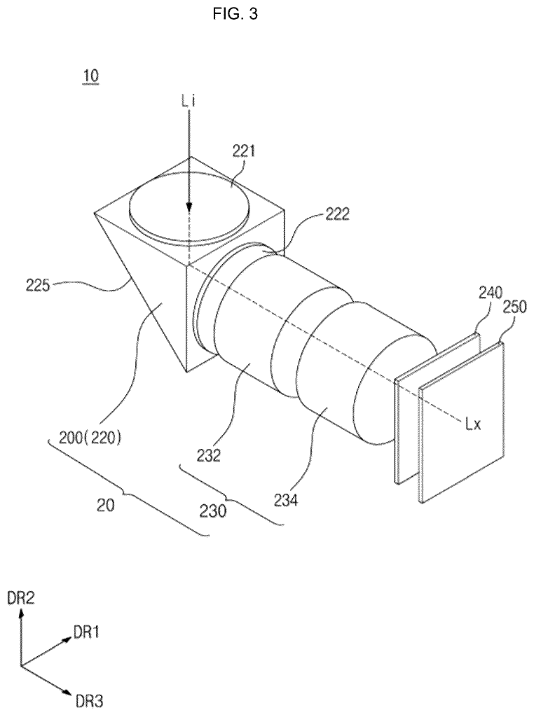

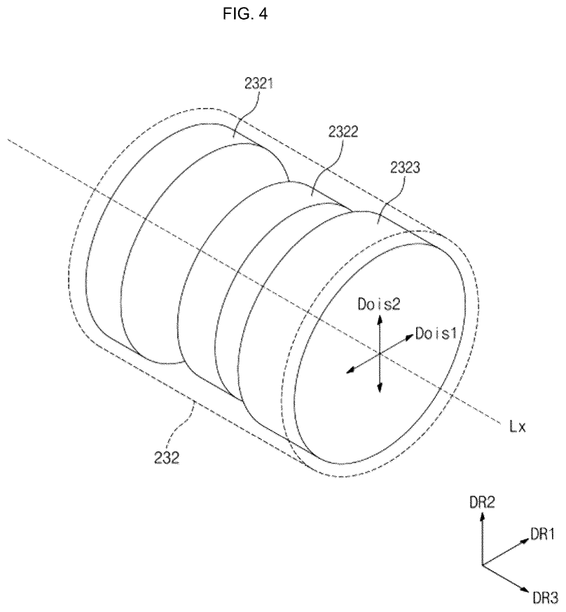

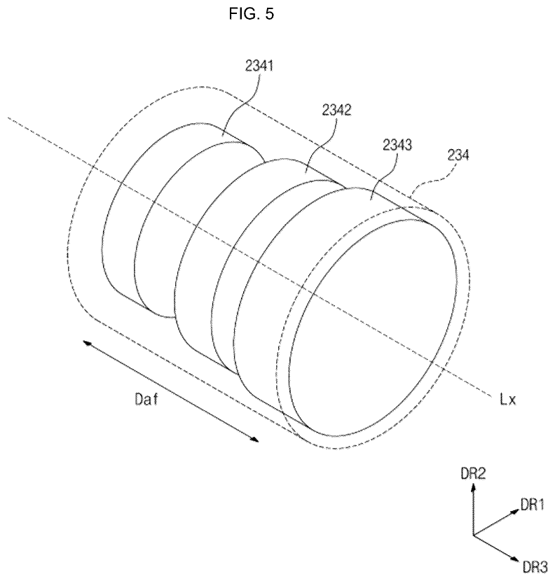

FIG. 3 is a perspective view of a portion of the camera module 10 according to an embodiment of the present disclosure. FIG. 4 is a perspective view of the first lens group 232 according to an embodiment of the present disclosure. FIG. 5 is a perspective view of the second lens group 234 according to an embodiment of the present disclosure.

Referring to FIGS. 3 to 5, the camera module 10 may include a lens assembly 20, a filter 240, and an image sensor 250. The lens assembly 20, the filter 240, and the image sensor 250 may be arranged in this order along the light travel direction.

The lens assembly 20 may include a light guide 200 and a lens group 230. The light guide 200 may guide the light that is input through the opening 12 to the lens group 230. The light guide 200 may guide the input light to the image sensor 250. The light guide 200 may change a travel path of the input light by using reflection or refraction of the light. For example, the light guide 200 may reflect or refract input light to change a travel path of the input light.

In an embodiment, the light guide 200 may include a reflector 220. The reflector 220 may reflect the input light toward the image sensor 250. For example, the reflector 220 may include a first surface 221 on an object side and a second surface 222 on an image side. The light may be input to or enter into the reflector 220 through the first surface 221, and may be output from or exit the reflector 220 through the second surface 222.

For example, the reflector 220 may further include a reflective surface 225 that reflects the light input through the first surface 221 toward the second surface 222. The light input to the reflector 220 through the first surface 221 may be incident on the reflector 220, and the light reflected from the reflector 220 may be output through the second surface 222. For example, the reflective surface 225 may include a mirror. Accordingly, the reflector 220 may switch a travel path of the light. For example, the reflector 220 may include a transparent material, and each of the first surface 221 and the second surface 222 may be a surface formed of or include the transparent material. For example, the reflective surface 225 may be a mirror formed on a surface of the transparent material. For example, the transparent material may be quartz, glass, or another transparent material.

In the reflector 220, one surface provided with the first surface 221 and another surface provided with the second surface 222 may be connected to or share a boundary with each other, and the reflective surface 225 may connect the one surface and the other surface to each other. For example, the reflective surface 225 may share a boundary with the first surface 221 and another boundary with the second surface 222. The reflector 220 may include a prism. For example, the reflector 220 may include a 90 degree prism. For example, the one surface and the other surface of the reflector 220 may be connected to each other perpendicularly to each other.

The light guide 200 may have a positive refractive power. For example, the reflector 220 may have a positive refractive power. In an embodiment, the first surface 221 of the reflector 220 may be convex. The second surface 222 of the reflector 220 may be convex. In an embodiment, both the first surface 221 and the second surface 222 of the reflector 220 may be convex aspherical surfaces.

In an embodiment, the reflector 220 may satisfy the following first inequality condition or inequality expression.

$$( fp / f ) \leq 2. \qquad [ First inequality condition ]$$

In the first inequality condition, fp may be a focal length of the reflector 220, and “f” may be a composite focal length of the camera module 10. For example, the composite focal length “f” of the camera module 10 may be a composite focal length of the light guide 200, the first lens group 232, and the second lens group 234 provided in the camera module 10. In an embodiment, the camera module 10 may further include a correction lens 210, and in this case, the composite focal length “f” of the camera module 10 may be a composite focal length of the light guide 200, the first lens group 232, the second lens group 234, and the correction lens 210.

Accordingly, aperture of the lenses belonging to the lens group 230 provided on an image side of the light guide 200 may be reduced.

The lens group 230 may be provided between the light guide 200 and the image sensor 250. The lens group 230 may include a first lens group 232 and a second lens group 234.

The first lens group 232 may include a plurality of lenses. The first lens group 232 may be moved in directions that cross the light travel direction. The light travel direction may be a light axis direction Lx. For example, the light travel direction may correspond to or may be a third direction DR3. For example, the first lens group 232 may be moved in a first correction direction Dois1 and a second correction direction Dois2 that cross the light travel direction. In an embodiment, the first correction direction Dois1 and the second correction direction Dois2 may be perpendicular to the light travel direction. For example, the first correction direction Dois1 and the second correction direction Dois2 may be perpendicular to the light axis direction Lx. Furthermore, the first correction direction Dois1 and the second correction direction Dois2 may be perpendicular to each other. For example, the first correction direction Dois1 may be parallel to a first direction DR1, and the second correction direction may be parallel to a second direction DR2.

Accordingly, the first lens group 232 may perform an optical image stabilization (OIS) function. The OIS function may be a function that compensates for movement or vibration so the image projected onto the image sensor stays steady and clear.

In an embodiment, the first lens group 232 may include a first lens 2321, a second lens 2322, and a third lens 2323 that are sequentially arranged from the object side to the image side. Among the lenses of the first lens group 232, the first lens 2321 may be closest to the light guide 200. Among the lenses of the first lens group 232, the second lens 2322 may be second closest to the light guide 200. For example, among the remaining lenses of the first lens group 232 other than the first lens 2321, the second lens 2322 may be closest to the first lens 2321. Among the lenses of the first lens group 232, the third lens 2323 may be third closest to the light guide 200. For example, among the remaining lenses of the first lens group 232 other than the first and second lenses 2321 and 2322, the third lens 2323 may be closest to the second lens 2322.

The first lens 2321 may have a positive refractive power. The second lens 2322 may have a negative refractive power.

Accordingly, the first lens group 232 may correct chromatic aberration.

The lenses included in the first lens group 232 may be moved together. For example, the first to third lenses 2321, 2322, and 2323 may be moved together in the first correction direction Dois1 and/or the second correction direction Dois2. In example embodiments, the first to third lenses 2321, 2322, and 2323 may be moved simultaneously in the first correction direction Dois1 and/or the second correction direction Dois2.

The second lens group 234 may include at least one lens. For example, the second lens group 234 may include a single lens or a plurality of lenses. In an embodiment, the second lens group 234 may include a fourth lens 2341, a fifth lens 2342, and a sixth lens 2343 that are sequentially arranged from the object side to the image side. Among the lenses of the second lens group 234, the fourth lens 2341 may be closest to the light guide 200. Among the lenses of the second lens group 234, the fifth lens 2342 may be second closest to the light guide 200. For example, among the remaining lenses of the second lens group 234 other than the fourth lens 2341, the fifth lens 2342 may be closest to the fourth lens 2341. Among the lenses of the second lens group 234, the sixth lens 2343 may be third closest to the light guide 200. For example, among the remaining lenses of the second lens group 234 other than the fourth and fifth lenses 2341 and 2342, the sixth lens 2343 may be closest to the fifth lens 2342.

The second lens group 234 may be fixed with respect to directions that cross the light travel direction. For example, the second lens group 234 may not move in the directions that cross the light travel direction. However, in an embodiment, the second lens group 234 may be moved in a direction that is parallel to the light travel direction. The driving direction of the second lens group 234 may be the same as a focusing direction Daf. For example, the second lens group 234 may not be moved in the first direction DR1 and the second direction DR2, but may be moved in a third direction DR3 that is parallel to the light travel direction. When a lens or a lens group is fixed or does not move as described in the present disclosure, the lens or the lens group may not move automatically, e.g., for focusing purposes and/or for shake correction purposes, while a camera module and/or an electronic device including the lens or the lens group is performing focusing and/or shake correction function.

Accordingly, the second lens group 234 may perform automatic focusing.

The first lens group 232 and the second lens group 234 may be driven independently from each other. For example, only one of the first lens group 232 and the second lens group 234 may be moved, or the first lens group 232 and the second lens group 234 may be moved together.

In an embodiment, the first lens group 232 and the second lens group 234 may satisfy the following second inequality condition or inequality expression.

$$\vert ( 1 - {m}_{1} ) \cdot {m}_{2} \vert \geq 1. \qquad [ Second inequality condition ]$$

Here, m₁ may be an imaging magnification of the first lens group 232, and m₂ may be an imaging magnification of the second lens group 234. The imaging magnification m₁ of the first lens group 232 may be a composite imaging magnification of the first lens group 232, and the imaging magnification m₂ of the second lens group 234 may be a composite imaging magnification of the second lens group 234.

Accordingly, the first lens group 232 may perform a specific level of a hand-shake correction function with a smaller movement amount. For example, compared to the image sensor shift method, the first lens group 232 may implement the same performance as that of the hand-shake correction function of the image sensor shift method with a smaller movement amount than the image sensor shift method. Accordingly, a smaller camera module 10 may be provided. Throughout the disclosure, “movement amount” may indicate “moving distance.” For example, “a smaller movement amount” may indicate “a shorter moving distance.”

In an embodiment, the second lens group 234 may satisfy the following third inequality condition or inequality expression.

$$\vert 1 - {( {m}_{2} )}^{2} \vert \geq 1. \qquad [ Third inequality condition ]$$

Here, m₂ may be an imaging magnification of the second lens group 234. The imaging magnification m₂ of the second lens group 234 may be a composite imaging magnification of the second lens group 234.

Accordingly, the second lens group 234 may perform a specific level of automatic focusing with a smaller movement amount. For example, compared to an optical system full shift method of performing autofocusing by moving all the lenses embedded in the camera module 10, the second lens group 234 may implement the same performance as the autofocusing performance of the optical system full shift method with a smaller movement amount than the movement amounts of the lenses of the optical system full shift method. Accordingly, a smaller camera module 10 may be provided.

The filter 240 may include a band pass filter 240 that filters light of a specific wavelength band, among the input lights. For example, the filter 240 may include an infrared filter 240.

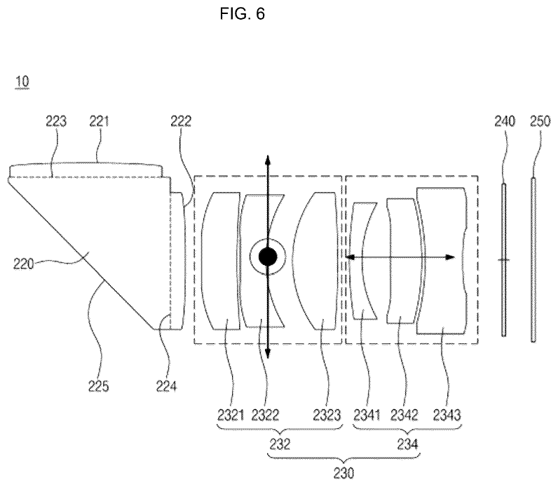

FIG. 6 is a cross-sectional view of a portion of the camera module 10 according to an embodiment of the present disclosure.

Referring to FIG. 6, in an embodiment, the camera module 10 may include a reflector 220, a first lens group 232, a second lens group 234, a filter 240, and an image sensor 250.

The reflector 220 may have a positive refractive power. The reflector 220 may have a first surface 221 and a second surface 222 that are convex. The first surface 221 may protrude convexly from a third surface/plane 223. The third surface/plane 223 may be a plane crossing the reflector 220. For example, a portion of a surface of the reflector 220 surrounding the protruding portion of the first surface 221 may be disposed on the third surface/plane 223. For example, the third surface/plane 223 may be an imaginary plane crossing the reflector 220 near the object side of the reflector 220. In certain embodiments, when the reflector 220 does not have a refractive power, e.g., when the reflector 220 has a flat first surface 221, the whole surface of the object side of the reflector 220 may be disposed on the third surface/plane 223. The second surface 222 may protrude convexly from a fourth surface/plane 224. The fourth surface/plane 224 may be a plane crossing the reflector 220. For example, a portion of a surface of the reflector 220 surrounding the protruding second surface 222 may be disposed on the fourth surface/plane 224. For example, the fourth surface/plane 224 may be an imaginary plane crossing the reflector 220 near the image side.

In certain embodiments, when the reflector 220 does not have a refractive power, e.g., when the reflector 220 has a flat second surface 222, the whole surface of the image side of the reflector 220 may be disposed on the fourth surface/plane 224.

The first lens group 232 may include first to third lenses 2321, 2322, and 2323, and the second lens group 234 may include fourth to sixth lenses 2341, 2342, and 2343.

The first lens group 232 may be moved in a direction that crosses the light travel direction. Accordingly, the first lens group 232 may perform a hand-shake correction function. The first lens 2321 may have a positive refractive power, and the second lens 2322 may have a negative refractive power.

The second lens group 234 may be moved in a direction that is parallel to the light travel direction. Accordingly, the second lens group 234 may perform an automatic focusing function.

Table 1 below is a table illustrating data of the components included in the camera module 10 according to an embodiment of the present disclosure.

TABLE 1

| | | | | | | | Composite |
|---|---|---|---|---|---|---|---|
| | | | | Thickness/ | | Focal | Focal |
| | | Surface/ | Radius | Distance | Glass | Length | Length |
| Group | Component | Plane | (mm) | (mm) | code | (mm) | (mm) |
| Object | | 0 | | D0 | | | |
| Light | Reflector | ASP 1 | 58.909 | 1.072 | 54401.5597 | 49 | 49.0 |
| guide | (220) | 2 | Infinity | 6.113 | 54401.5597 | | |
| (200) | | 3 | Infinity | 6.113 | 54401.5597 | | |
| | | 4 | Infinity | 1.110 | 54401.5597 | | |
| | | ASP 5 | −44.749 | D1 | | | |
| First | First lens | ASP 6 | 12.301 | 2.692 | 534800.557 | 32.98 | 17.64 |
| lens group | (2321) | ASP 7 | 37.263 | 0.202 | | | |
| (232) | Second lens | ASP 8 | 20.027 | 1.923 | 634337.233 | −17.87 | |
| | (2322) | ASP 9 | 7.001 | 1.861 | | | |
| | Third lens | ASP 10 | 8.572 | 3.243 | 53485.5571 | 11.97 | |
| | (2323) | ASP 11 | −22.248 | D2 | | | |
| Second | Fourth lens | ASP 12 | 50.051 | 0.939 | 53111.5567 | −19.86 | −13.46 |
| lens group | (2341) | ASP 13 | 8.680 | 2.080 | | | |
| (234) | Fifth lens | ASP 14 | −155.586 | 2.318 | 65034.2153 | 27.86 | |
| | (2342) | ASP 15 | −16.445 | 0.205 | | | |
| | Sixth lens | ASP 16 | −36.442 | 2.897 | 54401.5597 | −17.95 | |
| | (2343) | ASP 17 | 13.772 | D3 | | | |

| Filter (240) | 18 | Infinity | 0.210 | 5168.642 |
|---|---|---|---|---|
| | 19 | Infinity | 2.085 | |
| Image sensor (250) | 20 | Infinity | 0.004 | |

In Table 1, surface numbers 0 to 20 may indicate surfaces/planes that are sequentially arranged from the object side to the image side of the camera module 10 along the light travel direction. For example, surface ASP 1 may correspond to or may be the first surface 221 of the reflector 220, surface 2 may correspond to or may be the third surface/plane 223 of the reflector 220, surface 3 may correspond to or may be the reflective surface 225 of the reflector 220, surface 4 may correspond to or may be the fourth surface/plane 224 of the reflector 220, and surface ASP 5 may correspond to or may be the second surface 222 of the reflector 220.

Here, the ASP surfaces may represent aspherical surfaces, and surfaces that do not correspond to or do not include ASP may represent flat surfaces. For example, the first surface 221 and the second surface 222 of the reflector 220 corresponding to or represented by surfaces ASP 1 and ASP 5 may correspond to or may be aspherical surfaces, respectively, and the third surface/plane 223 and the fourth surface/plane 224 of the reflector 220 corresponding to or represented by surfaces 2 and 4 may correspond to or may be flat surfaces, respectively.

Furthermore, surfaces ASP 6 and ASP 7 may correspond to or may be one surface of the first lens 2321 on the object side and an opposite surface of the first lens 2321 on the image side, respectively. Surfaces ASP 8 and ASP 9 may correspond to or may be one surface of the second lens 2322 on the object side and an opposite surface of the second lens 2322 on the image side, respectively. Surfaces ASP 10 and ASP 11 may correspond to or may be one surface of the third lens 2323 on the object side and an opposite surface of the third lens 2323 on the image side, respectively. Surfaces ASP 12 and ASP 13 may correspond to or may be one surface of the fourth lens 2341 on the object side and an opposite surface of the fourth lens 2341 on the image side, respectively. Surfaces ASP 14 and ASP 15 may correspond to or may be one surface of the fifth lens 2342 on the object side and an opposite surface of the fifth lens 2342 on the image side, respectively. Surfaces ASP 16 and ASP 17 may correspond to or may be one surface of the sixth lens 2343 on the object side and an opposite surface of the sixth lens 2343 on the image side, respectively. Furthermore, surfaces 18 and 19 may correspond to or may be one surface of the filter 240 on the object side and an opposite surface of the filter 240 on the image side. Furthermore, the surface 20 may correspond to or may be one surface of the image sensor 250, through which light is input.

A shape of each of the ASP surfaces is determined by an aspheric coefficient, and the aspheric coefficient may be calculated by the following first equation.

$$z ( r ) = \frac{{r}^{2}}{R ( 1 + \sqrt{1 - ( 1 + k ) \frac{{r}^{2}}{{R}^{2}}} )} + {\sum }_{i = 2}^{N} {A}_{i} {r}^{2 i} \qquad [ Equation 1 ]$$

Here, z(r) may correspond to or may be a height of a surface at a distance “r” from an optical axis Lx. “r” may correspond to or may be a radius with respect to the optical axis Lx. “R” may correspond to or may be a radius of curvature. “k” may correspond to or may be a conic constant. Ai may correspond to or may be an aspheric coefficient. “N” may correspond to or may be a maximum order of the aspherical term.

Table 2 below illustrates an aspheric coefficient for determining the shape of each of the aspheric surfaces of the lenses according to an embodiment of the present disclosure.

TABLE 2

| Surface | k | A₁ | A₂ | A₃ | A₄ |
|---|---|---|---|---|---|
| ASP 1 | −15.21093356 | −1.449682E−05 | 2.111976E−07 | −6.939972E−09 | 8.771401E−11 |
| ASP 5 | 11.30413432 | 2.362307E−06 | 3.878325E−07 | −2.620370E−09 | |
| ASP 6 | −0.692850349 | −5.492733E−05 | −4.190871E−06 | −5.327385E−09 | −2.293738E−09 |
| ASP 7 | −14.96456016 | −5.598929E−05 | −2.485032E−06 | −1.733455E−07 | 4.152330E−10 |
| ASP 8 | −29.994267 | −3.610801E−05 | −1.033025E−06 | 8.327803E−08 | −1.692416E−09 |
| ASP 9 | −2.450193042 | −3.987324E−05 | −8.778077E−07 | −1.501272E−07 | 1.779794E−09 |
| ASP 10 | 0.528227346 | 2.571749E−06 | −2.495800E−06 | 7.324766E−08 | |
| ASP 11 | −34.72389172 | 1.946653E−04 | 1.179167E−05 | 1.752513E−07 | |
| ASP 12 | −38.72436032 | 2.699067E−04 | 1.194596E−05 | 1.614669E−07 | |
| ASP 13 | 2.000500497 | −6.185605E−04 | 8.749878E−06 | −1.540709E−07 | |
| ASP 14 | −92.21138959 | −2.422291E−04 | −3.053720E−05 | | |
| ASP 15 | −29.29161541 | 1.652015E−04 | −2.439144E−05 | | |
| ASP 16 | 6.567511084 | −5.723722E−04 | 5.247306E−07 | −9.185385E−08 | −9.811725E−09 |
| ASP 17 | −26.37311457 | −9.732344E−04 | 9.219875E−06 | −1.758477E−07 | |

Referring back to Table 1, the thickness/distance may represent the distance from the corresponding surface (e.g., the surface at the same row) to the next surface (e.g., the surface at an immediately below row). For example, the thickness/distance may represent the distance from an apex of the corresponding surface (e.g., the surface at the same row) to an apex of the next surface (e.g., the surface at an immediately below row). For example, the thickness/distance of surface ASP 1 may be a vertical distance from an apex of surface ASP 1 to surface 2. Furthermore, the thickness/distance of surface 2 may be a value that is obtained by subtracting the thickness of surface ASP 1 from a vertical distance from the apex of surface ASP 1 to surface 3.

Thickness/Distance DO may represent a distance from an object to the first surface 221 of the reflector 220. Thickness/Distance D1 may indicate a distance from the second surface 222 of the reflector 220 to the surface of the first lens 2321 on the object side. Thickness/Distance D2 may indicate a distance from the surface of the third lens 2323 on the image side to the surface of the fourth lens 2341 on the object side. Thickness/Distance D3 may indicate a distance from the surface of the sixth lens 2343 on the image side to the filter 240.

Table 3 illustrates distances D1 between the light guide 200 and the first lens group 232, distances D2 between the first lens group 232 and the second lens group 234, and distances D3 between the second lens group 234 and the filter 240 according to different distances DO from the object to the light guide 200. Units of distances DO to D3 are millimeters (mm).

TABLE 3

| | | | |
|---|---|---|---|
| D0 | Infinity | 1500 | 250 |
| D1 | 1.1912 | 1.1912 | 1.1912 |
| D2 | 1 | 1.257 | 2.628 |
| D3 | 2.8245 | 2.5684 | 1.2 |

Glass codes represent refractive indices (n_{d}) and Abbe numbers (V_{d}) that are optical properties of the lens materials, and with respect to the middle points “.” of the numbers, the former numbers represent the refractive indices (n_{d}) and the latter numbers represent the Abbe numbers (V_{d}). For example, a material having a value of glass code 54401.5597 is an optical material having a reflective index (n_{d}) of 1.54401 and an Abbe number (V_{d}) of 55.97. The refractive index and the Abbe number of each component may be closely related to the material of its corresponding component.

The focal length represents a focal length of each component, and the composite focal length may represent a composite focal length (e.g., an effective focal length) of the components included in each group. The focal length and the composite focal length are values that are measured based on or using a wavelength of 555 nm.

Based on the above data, referring to FIG. 6, in an embodiment, the imaging magnification m₁ of the first lens group 232 may be 0.3125, and the imaging magnification m₂ of the second lens group 234 may be 1.6. The imaging magnification m₁ of the first lens group 232 and the imaging magnification m₂ of the second lens group 234 may be values (e.g., ratios of image sizes to the object sizes) when the object is at infinity, e.g., when the distance DO is at infinity.

Furthermore, in an embodiment, a focal length fp of the reflector 220 may be 49 mm, and a composite focal length “f” of the camera module 10 may be 24.5 mm.

Based on this, the first lens group 232 and the second lens group 234 may satisfy the following first inequality condition:

$$( 49 / 24.5 ) = 2. \leq 2.$$

Accordingly, the apertures of lenses belonging to the first lens group 232 provided on the image side of the reflector 220 and/or the apertures of lenses belonging to the second lens group 234 may be reduced. Furthermore, a smaller camera module 10 may be provided.

Furthermore, based on this, the first lens group 232 and the second lens group 234 may satisfy the following second inequality condition:

$$\vert ( 1 - 0.3125 ) \cdot 1.6 \vert = 1.55 \geq 1.$$

Accordingly, the first lens group 232 may perform a specific level of a hand-shake correction function with a smaller movement amount. For example, compared to the image sensor shift method, the first lens group 232 may implement the same performance as that of the hand-shake correction function of the image sensor shift method with a smaller movement amount than the image sensor shift method. Accordingly, a smaller camera module 10 may be provided.

Furthermore, based on this, the second lens group 234 may satisfy the following third inequality condition:

$$\vert 1 - ( 1.6 ) 2 \vert = 1.56 \geq 1.$$

Accordingly, the second lens group 234 may perform a specific level of automatic focusing with a smaller movement amount. For example, compared to an optical system full shift method of performing autofocusing by moving all the lenses embedded in the camera module 10, the second lens group 234 may implement the same performance as the autofocusing performance of the optical system full shift method with a smaller movement amount than the movement amounts of the lenses of the optical system full shift method. Accordingly, a smaller camera module 10 may be provided.

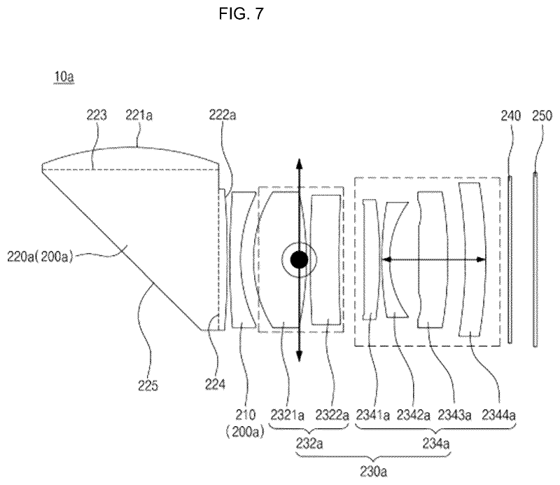

FIG. 7 is a cross-sectional view of a portion of a camera module 10a according to an embodiment of the present disclosure.

Referring to FIG. 7, in an embodiment, the camera module 10a may include a light guide 200a, a first lens group 232a, a second lens group 234a, a filter 240, and an image sensor 250. The light guide 200a may include a reflector 220a and a correction lens 210. The correction lens 210 may correct chromatic aberration.

The reflector 220a may have a positive refractive power. The reflector 220a may have a first surface 221a and a second surface 222a that are convex. The first surface 221a may protrude convexly from a third surface/plane 223. The third surface/plane 223 may be a plane crossing the reflector 220a. For example, a portion of a surface of the reflector 220a surrounding the protruding portion of the first surface 221a may be disposed on the third surface/plane 223. For example, the third surface/plane 223 may be an imaginary plane crossing the reflector 220a near the object side of the reflector 220a. In certain embodiments, when the reflector 220a does not have a refractive power, e.g., when the reflector 220a has a flat first surface 221a, the whole surface of the object side of the reflector 220a may be disposed on the third surface/plane 223. The second surface 222a may protrude convexly from the fourth surface/plane 224. The fourth surface/plane 224 may be a plane crossing the reflector 220a. For example, a portion of a surface of the reflector 220a surrounding the protruding second surface 222a may be disposed on the fourth surface/plane 224. For example, the fourth surface/plane 224 may be an imaginary plane crossing the reflector 220a near the image side. In certain embodiments, when the reflector 220a does not have a reflective power, e.g., when the reflector 220a has a flat second surface 222a, the whole surface of the image side of the reflector 220a may be disposed on the fourth surface/plane 224.

The first lens group 232a may include a first lens 2321a and a second lens 2322a, and the second lens group 234a may include a third lens 2341a, a fourth lens 2342a, a fifth lens 2343a, and a sixth lens 2344a.

The first lens group 232a may be moved in a direction that crosses the light travel direction. Accordingly, the first lens group 232a may perform a hand-shake correction function.

The first lens 2321a may have a positive refractive power, and the second lens 2322a may have a negative refractive power.

The second lens group 234a may be moved in a direction that is parallel to the light travel direction. Accordingly, the second lens group 234a may perform an automatic focusing function.

Table 4 below is a table illustrating data of the components included in the camera module 10a according to an embodiment of the present disclosure.

TABLE 4

| | | | | | | | Composite |
|---|---|---|---|---|---|---|---|
| | | | | | | Focal | Focal |
| | | Surface/ | Radius | Thickness | Glass | Length | Length |
| Group | Component | Plane | (mm) | (mm) | code | (mm) | (mm) |
| Object | | 0 | | D0 | | | |
| Light | Reflector | ASP 1 | 16.150 | 1.507 | 54401.5597 | 27.0 | −270.473 |
| guide | (220a) | 2 | Infinity | 6.200 | 54401.5597 | | |
| (200) | | 3 | Infinity | 6.000 | 54401.5597 | | |
| | | 4 | Infinity | 0.600 | 54401.5597 | | |
| | | ASP 5 | −115.650 | 0.200 | | | |
| | Correction | ASP 6 | 80.767 | 0.600 | 600961.2895 | −16.31 | |
| | lens | ASP 7 | 8.763 | D1 | | | |
| | (210) | | | | | | |
| First | First lens | ASP 8 | 7.971 | 3.598 | 54401.5597 | 10.60 | 11.652 |
| lens | (2321a) | ASP 9 | −17.730 | 0.205 | | | |
| group | Second lens | ASP 10 | 88.066 | 1.881 | 68042.1815 | −76.46 | |
| (232a) | (2322a) | ASP 11 | 32.618 | D2 | | | |
| Second | Third lens | ASP 12 | −114.544 | 1.000 | 534800.557 | 132.86 | −16.886 |
| lens | (2341a) | ASP 13 | −44.075 | 0.177 | | | |
| group | Fourth lens | ASP 14 | 25.680 | 0.553 | 54401.5597 | −17.27 | |
| (234a) | (2342a) | ASP 15 | 6.843 | 2.000 | | | |
| | Fifth lens | ASP 16 | 51.746 | 2.000 | 68042.1815 | 41.84 | |
| | (2343a) | ASP 17 | −63.658 | 1.420 | | | |
| | Sixth lens | ASP 18 | −13.237 | 1.212 | 538301.5288 | −32.54 | |
| | (2344a) | ASP 19 | −55.322 | D3 | | | |

| Filter (240) | 20 | Infinity | 0.210 | 5168.642 |
|---|---|---|---|---|
| | 21 | Infinity | 1.653 | |
| Image sensor (250) | 22 | Infinity | 0.000 | |

In Table 4, surface numbers 0 to 22 may indicate surfaces that are sequentially arranged from the object side to the image side along the light travel direction. The focal length and the composite focal length are values that are measured based on or using a wavelength of 555 nm.

Table 5 below illustrates an aspheric coefficient for determining the shape of each of the aspheric surfaces of the lenses according to an embodiment of the present disclosure.

TABLE 5

| Surface | k | A₁ | A₂ | A₃ | A₄ |
|---|---|---|---|---|---|
| ASP 1 | −0.450638802 | −1.678597E−05 | −1.525585E−07 | −4.421478E−11 | −3.390972E−12 |
| ASP 5 | 47.50733775 | 2.289390E−05 | 8.206445E−07 | −1.033459E−09 | −1.270213E−10 |
| ASP 6 | 98.38982352 | 2.952321E−06 | −2.281139E−07 | 4.865917E−08 | −7.776811E−10 |
| ASP 7 | −0.261236892 | −9.708839E−05 | −2.135651E−06 | 8.991302E−08 | −2.150254E−09 |
| ASP 8 | −0.419254859 | −8.071890E−05 | 1.352023E−06 | 4.102450E−08 | −3.587373E−09 |
| ASP 9 | −9.754292667 | 4.318846E−05 | 8.756112E−07 | −7.948078E−08 | 1.618418E−09 |
| ASP 10 | −99 | 1.406669E−05 | −1.427418E−07 | 5.193501E−10 | 8.626848E−09 |
| ASP 11 | −32.54424628 | 8.677067E−05 | 1.025836E−06 | 2.174394E−07 | 8.778902E−09 |
| ASP 12 | −99 | 3.424877E−05 | −4.066048E−06 | 2.650061E−07 | 4.936239E−09 |
| ASP 13 | 61.87657502 | −5.532340E−05 | −3.020704E−06 | 4.836608E−07 | 5.360538E−09 |
| ASP 14 | 15.37781152 | 1.580622E−04 | 5.955718E−07 | −1.196502E−06 | 9.818892E−09 |
| ASP 15 | 0.463966601 | 2.049862E−04 | 1.579464E−05 | −8.233494E−07 | −3.262340E−08 |
| ASP 16 | 55.42584852 | −6.011717E−04 | −1.710395E−05 | 1.295327E−07 | 2.348044E−09 |
| ASP 17 | 91.56361332 | −2.067644E−04 | −2.026537E−05 | 3.751715E−07 | −1.661472E−09 |
| ASP 18 | −2.152652984 | −1.335724E−04 | 3.104214E−05 | −2.441747E−07 | −1.714434E−09 |
| ASP 19 | 64.51414429 | −7.084564E−04 | 2.484984E−05 | −3.617559E−07 | 1.050101E−09 |

Table 6 illustrates distances D1 between the light guide 200a and the first lens group 232a, distances D2 between the first lens group 232a and the second lens group 234a, and distances D3 between the second lens group 234a and the filter 240 according to different distances DO from the object to the light guide 200a. Units of distances DO to D3 are millimeters (mm).

TABLE 6

| | | | |
|---|---|---|---|
| D0 | Infinity | 4200 | 1200 |
| D1 | 1.000 | 1.000 | 1.000 |
| D2 | 1.305 | 1.461 | 1.872 |
| D3 | 2.015 | 1.860 | 1.450 |

Based on the above data, referring to FIG. 7, in an embodiment, the imaging magnification m₁ of the first lens group 232a may be −0.0689, and the imaging magnification m₂ of the second lens group 234a may be 1.449. The imaging magnification m₁ of the first lens group 232a and the imaging magnification m₂ of the second lens group 234a may be values (e.g., ratios 10 of image sizes to the object sizes) when the object is at infinity, e.g., when the distance DO is at infinity.

Furthermore, in an embodiment, the focal length fp of the reflector 220a may be 27 mm, and the composite focal length “f” of the camera module 10a may be 27 mm.

Based on this, the first lens group 232a and the second lens group 234a may satisfy the following first inequality condition:

$$( 27 / 27 ) = 1. \leq 2.$$

Accordingly, the apertures of lenses belonging to the first lens group 232a provided on the image side of the reflector 220a and/or the apertures of lenses belonging to the second lens group 234a may be reduced. Furthermore, a smaller camera module 10a may be provided. Furthermore, based on this, the first lens group 232a and the second lens group [00122] 234a may satisfy the following second inequality condition:

$$\vert ( 1 - ( - 0.0689 ) ) \cdot 1.449 \vert = 1.54884 \geq 1.$$

Accordingly, the first lens group 232a may perform a specific level of a hand-shake correction function with a smaller movement amount. For example, compared to the image sensor shift method, the first lens group 232a may implement the same performance as that of the hand-shake correction function of the image sensor shift method with a smaller movement amount than the image sensor shift method. Accordingly, a smaller camera module 10a may be provided.

Furthermore, based on this, the second lens group 234a may satisfy the following third inequality condition:

$$\vert 1 - ( 1.449 ) 2 \vert = 1.0996 \geq 1.$$

Accordingly, the second lens group 234a may perform a specific level of automatic focusing with a smaller movement amount. For example, compared to an optical system full shift method of performing autofocusing by moving all the lenses embedded in the camera module 10a, the second lens group 234a may implement the same performance as the autofocusing performance of the optical system full shift method with a smaller movement amount than the movement amounts of the lenses of the optical system full shift method. Accordingly, a smaller camera module 10a may be provided.

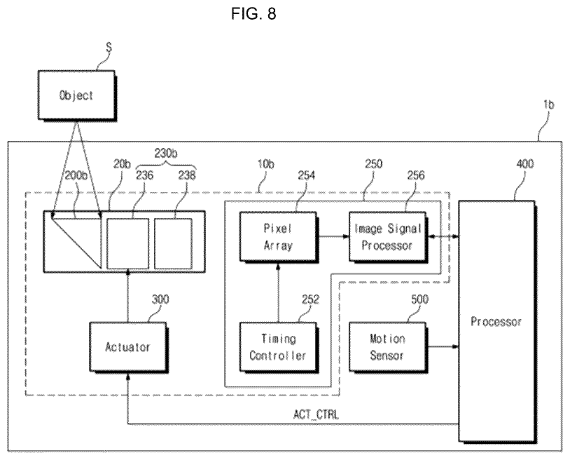

FIG. 8 is a block diagram of an electronic device 1b according to an embodiment of the present disclosure.

The components that constitute the electronic device 1b and the materials that constitute them, which will be described below, are substantially the same as the components of the electronic device 1 described above with reference to FIG. 2. Accordingly, for convenience of description, differences from the above-described electronic device 1 will be mainly described, and duplicative descriptions will not be repeated.

Referring to FIG. 8, in an embodiment, an electronic device 1b may include a camera module 10b, a processor 400, and a motion sensor 500. The camera module 10a may include an image sensor 250, a lens assembly 20b, and an actuator 300.

The lens assembly 20b is a component, through which input light passes, and may include a light guide 200b and a lens group 230b. The light guide 200b may receive light, and may guide the received light to the lens group 230b. However, the present disclosure is not limited thereto, and the lens assembly 20b may include all components through which the received light passes. The lens assembly 20b may be an optical system.

For example, the lens group 230b may include a driven lens group 236 and a fixed lens group 238. The driven lens group 236 may include a plurality of lenses. The fixed lens group 238 may include at least one lens. For example, the driven lens group 236 may perform hand-shake correction functions and automatic focusing functions. To this end, the driven lens group 236 may be driven independently of the fixed lens group 238. The actuator 300 may drive the driven lens group 236.

The processor 400 may control overall operations of the electronic device 1b. The processor 400 may control movement of the driven lens group 236 by providing a control signal to the actuator 300. For example, the processor 400 may provide a control signal based on vector data provided from the motion sensor 500 to the processor 400, to the actuator 300, and may control the movement of the driven lens group 236. For example, the actuator 300 may move the driven lens group 236 in directions that cross the light travel direction based on the control signal of the processor 400. Accordingly, the electronic device 1b may perform a hand-shake correction function.

Furthermore, the processor 400 may provide a control signal based on phase data provided from the image sensor 250 to the processor 400, to the actuator 300, and may control the movement of the driven lens group 236. For example, the actuator 300 may move the driven lens group 236 in directions that are parallel to the light travel direction based on the control signal received from the processor 400. Accordingly, the electronic device 1b may perform automatic focusing.

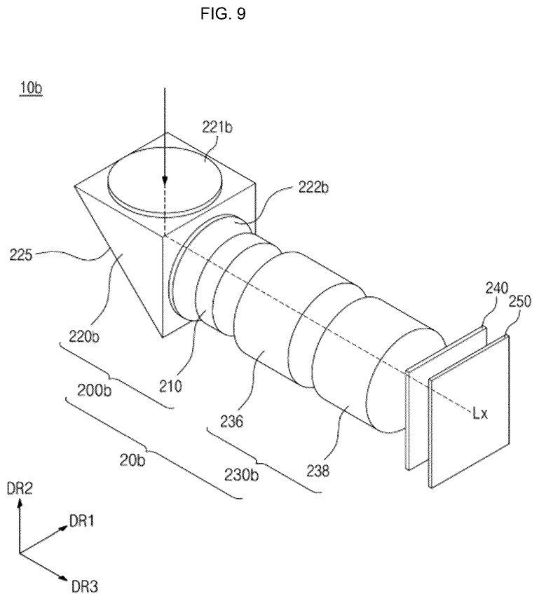

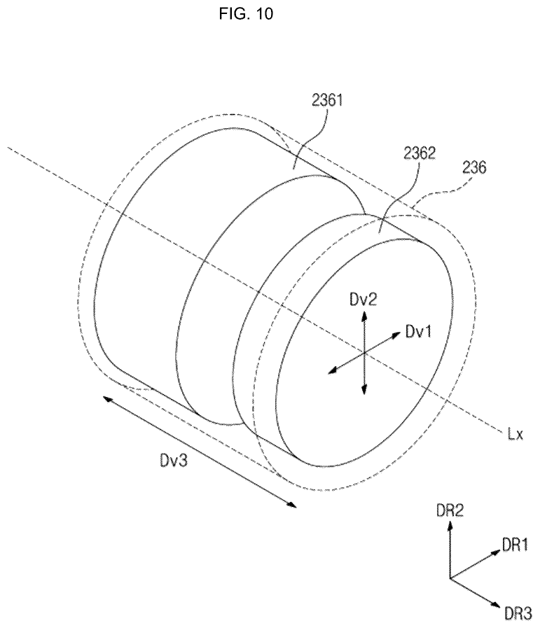

FIG. 9 is a perspective view of a portion of the camera module 10b according to an embodiment of the present disclosure. FIG. 10 is a perspective view of a driven lens group 236 according to an embodiment of the present disclosure.

Referring to FIGS. 9 and 10, the camera module 10b may include a lens assembly 20b, a filter 240, and an image sensor 250. The lens assembly 20b, the filter 240, and the image sensor 250 may be arranged in the light travel direction.

The lens assembly 20b may include a light guide 200b and a lens group 230b. The light guide 200b may guide the light that is input through the opening 12 to the lens group 230b. The light guide 200b may guide the input light to the image sensor 250. The light guide art 200b may change a travel path of the input light by using reflection or refraction of the light.

In an embodiment, the light guide 200b may include a reflector 220b and a correction lens 210. The reflector 220b may reflect the input light toward the image sensor 250. For example, the reflector 220b may include a first surface 221b on an object side and a second surface 222b on an image side. The light may be input to the reflector 220b through the first surface 221b, and may be output from the reflector 220b through the second surface 222b. The correction lens 210 may correct chromatic aberration.

For example, the reflector 220b may further include a reflective surface 225 that reflects the light input through the first surface 221b toward the second surface 222b. For example, the reflective surface 225 may include a mirror. Accordingly, the reflector 220b may switch a travel path of the light.

In the reflector 220b, one surface provided with the first surface 221b and another surface provided with the second surface 222b may be connected to (e.g., share a boundary with) each other, and the reflective surface 225 may connect the one surface and the other surface to each other. For example, the reflective surface 225 may share a boundary with the one surface and share another boundary with the other surface. The reflector 220b may include or may be a prism. For example, the reflector 220b may include or may be a 90 degree prism. For example, the one surface and the other surface of the reflector 220b may be connected to each other perpendicularly to each other.

The light guide 200b may have a positive refractive power. For example, the reflector 220b may have a positive refractive power. In an embodiment, the first surface 221b of the reflector 220b may be convex. The second surface 222b of the reflector 220b may be convex. In an embodiment, the first surface 221b and the second surface 222b of the reflector 220b may be convex aspherical surfaces.

In an embodiment, the reflector 220b may satisfy the following first inequality condition or inequality expression.

$$( fp / f ) \leq 2. \qquad [ First inequality condition ]$$

In the first inequality condition, fp may be a focal length of the reflector 220b, and “f” may be a composite focal length of the camera module 10b. For example, the composite focal length “f” of the camera module 10b may be the composite focal length of the light guide 200b, the driven lens group 236, and the fixed lens group 238 provided in the camera module 10b.

Accordingly, aperture of the lenses belonging to the lens group 230b provided on an image side of the light guide 200b may be reduced.

The lens group 230b may be provided between the light guide 200b and the image sensor 250. The lens group 230b may include a driven lens group 236 and a fixed lens group 238.

The driven lens group 236 may include a plurality of lenses. The driven lens group 236 may be moved in directions that cross the light travel direction. The light travel direction may be an optical axis direction Lx. For example, the light travel direction may correspond to or may be the third direction DR3. For example, the driven lens group 236 may be moved in a first driving direction Dv1 and a second driving direction Dv2 that cross the light travel direction. In an embodiment, the first driving direction Dv1 and the second driving direction Dv2 may be perpendicular to the light travel direction. Furthermore, the first driving direction Dv1 and the second driving direction Dv2 may be perpendicular to each other. For example, the first driving direction Dv1 may be parallel to the first direction DR1, and the second driving direction Dv2 may be parallel to the second direction DR2.

Accordingly, the driven lens group 236 may perform an optical image stabilization (OIS) function.

Furthermore, the driven lens group 236 may move in a direction that is parallel to the light travel direction. For example, the driven lens group 236 may be moved in a third driving direction Dv3 that is parallel to the light travel direction. The third driving direction Dv3 may be a focusing direction. In an embodiment, the third driving direction Dv3 may be perpendicular to the first driving direction Dv1 and the second driving direction Dv2. For example, the third driving direction Dv3 may be parallel to the third direction DR3.

Accordingly, the driven lens group 236 may perform automatic focusing.

In an embodiment, the driven lens group 236 may include a first lens 2361 and a second lens 2362 that are sequentially arranged from the object side to the image side. Among the lenses of the driven lens group 236, the first lens 2361 may be closest to the light guide 200b. Among the lenses of the driven lens group 236, the second lens 2362 may be second closest to the light guide 200b.

The first lens 2361 may have a positive refractive power. The second lens 2362 may have a negative refractive power.

Accordingly, the driven lens group 236 may correct chromatic aberration.

The lenses included in the driven lens group 236 may be moved together. For example, the first and second lenses 2361 and 2362 may be moved together in the first driving direction Dv1 and/or the second driving direction Dv2.

The fixed lens group 238 may include at least one lens. For example, the fixed lens group 238 may include a single lens or a plurality of lenses.

The fixed lens group 238 may be fixed in directions that cross the light travel direction. The fixed lens group 238 may not be moved in the directions that cross the light travel direction. Furthermore, the fixed lens group 238 may be fixed in a direction that is parallel to the light travel direction.

In an embodiment, the driven lens group 236 and the fixed lens group 238 may satisfy the following second inequality condition or inequality expression.

$$\vert ( 1 - {m}_{1} ) \cdot {m}_{2} \vert \geq 1. \qquad [ Second inequality condition ]$$

Here, m₁ may be an imaging magnification of the driven lens group 236, and m₂ may be an imaging magnification of the fixed lens group 238. The imaging magnification m₁ of the driven lens group 236 may be a composite imaging magnification of the driven lens group 236, and the imaging magnification m₂ of the fixed lens group 238 may be a composite imaging magnification of the fixed lens group 238.

Accordingly, the driven lens group 236 may perform a specific level of a hand-shake correction function with a smaller movement amount. For example, compared to the image sensor shift method, the driven lens group 236 may implement the same performance as that of the hand-shake correction function of the image sensor shift method with a smaller movement amount than the image sensor shift method. Accordingly, a smaller camera module 10b may be provided.

In an embodiment, the driven lens group 236 and the fixed lens group 238 may satisfy the following fourth inequality condition or inequality expression.

$$\vert ( 1 - {( {m}_{1} )}^{2} ) \cdot {m}_{2}^{2} \vert \geq 1. \qquad [ Fourth inequality condition ]$$

Here, m₁ may be an imaging magnification of the driven lens group 236, and m₂ may be an imaging magnification of the fixed lens group 238. The imaging magnification m₁ of the driven lens group 236 may be a composite imaging magnification of the driven lens group 236, and the imaging magnification m₂ of the fixed lens group 238 may be a composite imaging magnification of the fixed lens group 238.

Accordingly, the driven lens group 236 may perform a specific level of automatic focusing with a smaller movement amount. For example, compared to an optical system full shift method of performing autofocusing by moving all the lenses embedded in the camera module, the driven lens group 236 may implement the same performance as the autofocusing performance of the optical system full shift method with a smaller movement amount than the movement amounts of the lenses of the optical system full shift method. Accordingly, a smaller camera module 10b may be provided. Furthermore, a minimum distance from an object for automatic focusing may be reduced.

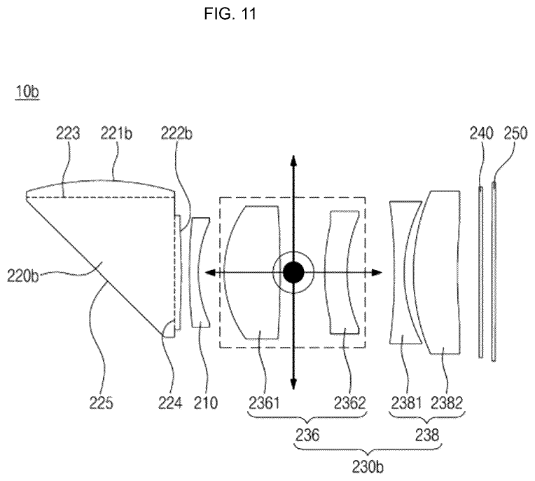

FIG. 11 is a cross-sectional view of a portion of the camera module 10b according to an embodiment of the present disclosure.

Referring to FIG. 11, the camera module 10b may include a reflector 220b, a correction lens 210, a driven lens group 236, a fixed lens group 238, a filter 240, and an image sensor 250.

The reflector 220b may have a positive refractive power. The reflector 220b may have a first surface 221b and a second surface 222b that are convex. The first surface 221b may protrude convexly from the third surface/plane 223. The third surface/plane 223 may be a plane crossing the reflector 220b. For example, a portion of a surface of the reflector 220b surrounding the protruding portion of the first surface 221b may be disposed on the third surface/plane 223. For example, the third surface/plane 223 may be an imaginary plane crossing the reflector 220b near the object side of the reflector 220b. In certain embodiments, when the reflector 220b does not have a refractive power, e.g., when the reflector 220b has a flat first surface 221b, the whole surface of the object side of the reflector 220b may be disposed on the third surface/plane 223. The second surface 222b may protrude convexly from the fourth surface/plane 224. The fourth surface/plane 224 may be a plane crossing the reflector 220b. For example, a portion of a surface of the reflector 220 surrounding the protruding second surface 222b may be disposed on the fourth surface/plane 224. For example, the fourth surface/plane 224 may be an imaginary plane crossing the reflector 220b near the image side. In certain embodiments, when the reflector 220b does not have a refractive power, e.g., when the reflector 220b has a flat second surface 222b, the whole surface of the image side of the reflector 220b may be disposed on the fourth surface/plane 224.

The correction lens 210 may be provided between the reflector 220b and the driven lens group 236, e.g., along the travel path of the light.

The driven lens group 236 may include first and second lenses 2361 and 2362, and the fixed lens group 238 may include third and fourth lenses 2381 and 2382.

The driven lens group 236 may be moved in directions that cross the light travel direction. Accordingly, the driven lens group 236 may perform a hand-shake correction function. The first lens 2361 may have a positive refractive power, and the second lens 2362 may have a negative refractive power.

Furthermore, the driven lens group 236 may move in a direction that is parallel to the light travel direction. Accordingly, the driven lens group 236 may perform an automatic focusing function.

Table 7 below is a table illustrating data of the components included in the camera module 10b according to an embodiment of the present disclosure.

TABLE 7

| | | | | | | | Composite |
|---|---|---|---|---|---|---|---|
| | | | | | | Focal | Focal |
| | | Surface/ | Radius | Thickness | Glass | Length | Length |
| Group | Component | Plane | (mm) | (mm) | code | (mm) | (mm) |
| Object | | 0 | | D0 | | | |
| Light | Reflector | ASP 1 | 16.151 | 1.114 | 535759.5489 | 25.828 | 248.169 |
| guide | (220b) | 2 | Infinity | 5.200 | 535759.5489 | | |
| (200b) | | 3 | Infinity | 5.000 | 535759.5489 | | |
| | | 4 | Infinity | 0.496 | 535759.5489 | | |
| | | ASP 5 | −73.609 | 0.550 | | | |
| | Correction | ASP 6 | 54.187 | 0.600 | 580037.3176 | −16.509 | |
| | lens | ASP 7 | 8.144 | D1 | | | |
| | (210) | | | | | | |
| Driven | First lens | ASP 8 | 7.850 | 3.800 | 533603.7464 | 12.544 | 13.991 |
| lens group | (2361) | ASP 9 | −38.410 | 3.106 | | | |
| (236) | Second lens | ASP 10 | 11.638 | 1.494 | 609327.2552 | −41.017 | |
| | (2362) | ASP 11 | 7.570 | D2 | | | |
| Fixed lens | Third lens | ASP 12 | 34.058 | 0.700 | 534800.557 | −16.286 | −44.301 |
| group | (2381) | ASP 13 | 6.904 | 0.571 | | | |
| (238) | Fourth lens | ASP 14 | 13.865 | 3.000 | 662730.2011 | 25.724 | |
| | (2382) | ASP 15 | 65.306 | 1.500 | | | |

| Filter (240) | 16 | Infinity | 0.21 | 5168.642 |
|---|---|---|---|---|
| | 17 | Infinity | D3 | |
| Image sensor (250) | 18 | Infinity | 0.005 | |

In Table 7, surface numbers 0 to 18 may indicate surfaces that are sequentially arranged from the object side to the image side along the light travel direction. The focal length and the composite focal length are values that are measured based on or using a wavelength of 555 nm.

Table 8 below illustrates an aspheric coefficient for determining the shape of each of the aspheric surfaces of the lenses according to an embodiment of the present disclosure.

TABLE 8

| Surface | k | A₁ | A₂ | A₃ | A₄ |
|---|---|---|---|---|---|
| ASP 1 | −0.823761 | −3.811411E−05 | −6.069425E−07 | 7.277697E−09 | −1.378413E−10 |
| ASP 5 | −57.789800 | 0 | 0 | 0 | 0 |
| ASP 6 | −97.920656 | 3.119496E−05 | 1.567686E−05 | −2.440754E−07 | −4.831422E−09 |
| ASP 7 | −0.344432 | −2.390059E−04 | 1.149271E−05 | 1.298938E−07 | −1.534947E−08 |
| ASP 8 | 0.107893 | −1.111460E−05 | −2.388736E−06 | −5.225661E−08 | 6.335598E−09 |
| ASP 9 | 18.030372 | 2.800104E−04 | 1.858761E−06 | −4.764196E−07 | 2.325290E−08 |
| ASP 10 | 0.937656 | −9.311068E−04 | −3.899561E−05 | −3.444177E−07 | 3.819637E−08 |
| ASP 11 | 0.104170 | −8.136116E−04 | −6.973739E−05 | 1.738150E−06 | 2.113114E−09 |
| ASP 12 | 41.733601 | −2.962316E−03 | 8.767843E−05 | −1.053330E−07 | −4.000040E−08 |
| ASP 13 | −1.126573 | −2.298989E−03 | 5.952285E−05 | 7.303149E−07 | −3.010183E−08 |
| ASP 14 | 3.883374 | 5.670708E−04 | −7.206182E−05 | 2.489983E−06 | −3.403237E−08 |
| ASP 15 | 10.171371 | 4.749165E−04 | −3.553333E−05 | 8.118395E−07 | −8.584862E−09 |

Table 9 illustrates distances D1 between the light guide 200b and the driven lens group 236, distances D2 between the driven lens group 236 and the fixed lens group 238, and distances D3 between the fixed lens group 238 and the filter 240 according to different distances DO from the light guide 200b to the object. Units of distances DO to D3 are millimeters (mm).

TABLE 9

| | | | |
|---|---|---|---|
| D0 | Infinity | 1500 | 500 |
| D1 | 1.765 | 1.452 | 0.774 |
| D2 | 3.181 | 3.501 | 4.181 |
| D3 | 0.780 | 0.780 | 0.780 |

Based on the above data, referring to FIG. 11, in an embodiment, the imaging magnification m₁ of the driven lens group 236 may be −0.0872, and the imaging magnification m₂ of the fixed lens group 238 may be 1.1037. The imaging magnification m₁ of the driven lens group 236 and the imaging magnification m₂ of the fixed lens group 238 may be values (e.g., ratios of image sizes to the object sizes) when the object is at infinity, for example, when the distance DO is at infinity.

Furthermore, in an embodiment, the focal length fp of the reflector 220b may be 25.827 mm, and the composite focal length “f” of the camera module 10b may be 23.886 mm.

Based on this, the driven lens group 236 and the fixed lens group 238 may satisfy the following first inequality condition:

$$( 25.827 / 23.886 ) = 1.08126 \leq 2.$$

Accordingly, the apertures of lenses belonging to the driven lens group 236 provided on the image side of the reflector 220b and/or the apertures of lenses belonging to the fixed lens group 238 may be reduced. Furthermore, a smaller camera module 10b may be provided. Furthermore, based on this, the driven lens group 236 and the fixed lens group 238 [00181] may satisfy the following second inequality condition:

$$\vert ( 1 - ( - 0.0872 ) ) \cdot 1.1037 \vert = 1.19994 \geq 1.$$

Accordingly, the driven lens group 236 may perform a specific level of a hand-shake correction function with a smaller movement amount. For example, compared to the image sensor shift method, the driven lens group 236 may implement the same performance as that of the hand-shake correction function of the image sensor shift method with a smaller movement amount than the image sensor shift method. Accordingly, a smaller camera module 10b may be provided.

Furthermore, based on this, the driven lens group 236 and the fixed lens group 238 may satisfy the following fourth inequality condition:

$$\vert ( 1 - ( - 0.0872 ) 2 ) \cdot 1.10372 \vert = 1.20889 \geq 1.$$

Accordingly, the driven lens group 236 may perform a specific level of automatic focusing with a smaller movement amount. For example, compared to an optical system full shift method of performing autofocusing by moving all the lenses embedded in the camera module 10b, the driven lens group 236 may implement the same performance as the autofocusing performance of the optical system full shift method with a smaller movement amount than the movement amounts of the lenses of the optical system full shift method. Accordingly, a smaller camera module 10b may be provided.

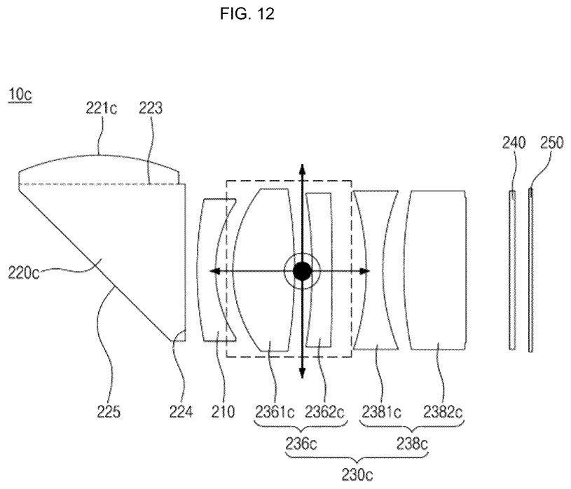

FIG. 12 is a cross-sectional view of a portion of a camera module 10c according to an embodiment of the present disclosure.

Referring to FIG. 12, the camera module 10c may include a reflector 220c, a correction lens 210, a driven lens group 236c, a fixed lens group 238c, a filter 240, and an image sensor 250.

The reflector 220c may have a positive refractive power. The reflector 220c may have a convex first surface 221c. The first surface 221c may protrude convexly from the third surface/plane 223. The third surface/plane 223 may be a plane crossing the reflector 220c. For example, a portion of a surface of the reflector 220c surrounding the protruding portion of the first surface 221c may be disposed on the third surface/plane 223. For example, the third surface/plane 223 may be an imaginary plane crossing the reflector 220c near the object side of the reflector 220c. In certain embodiments, when the reflector 220c does not have a refractive power, e.g., when the reflector 220c has a flat first surface 221c, the whole surface of the object side of the reflector 220c may be disposed on the third surface/plane 223. The reflector 220c may have a flat fourth surface/plane 224. The fourth surface/plane 224 may be a surface of the reflector 220c on the image side. Light that is input on the reflector 220c through the first surface 221c may be output through the fourth surface/plane 224.

The correction lens 210 may be provided between the reflector 220c and the driven lens group 236c.

The driven lens group 236c may include first and second lenses 2361c and 2362c, and the fixed lens group 238c may include third and fourth lenses 2381c and 2382c.

The driven lens group 236c may be moved in directions that cross the light travel direction. Accordingly, the driven lens group 236c may perform a hand-shake correction function. The first lens 2361c may have a positive refractive power, and the second lens 2362c may have a negative refractive power.

Furthermore, the driven lens group 236c may move in a direction that is parallel to the light travel direction. Accordingly, the driven lens group 236c may perform an automatic focusing function.

Table 10 below is a table illustrating data of the components included in the camera module 10c according to an embodiment of the present disclosure.

TABLE 10

| | | | | | | | Composite |
|---|---|---|---|---|---|---|---|
| | | | | Thickness/ | | Focal | Focal |
| | | Surface/ | Radius | Distance | Glass | Length | Length |
| Group | Component | Plane | (mm) | (mm) | code | (mm) | (mm) |
| Object | | 0 | | D0 | | | |
| Light | Reflector | ASP 1 | 4.847 | 0.658 | 54401.5597 | 8.87 | 56.634 |
| guide | (220c) | 2 | Infinity | 2.000 | 54401.5597 | | |
| (200c) | | 3 | Infinity | 2.000 | 54401.5597 | | |
| | | 4 | Infinity | 0.300 | | | |
| | Correction | ASP 5 | 11.175 | 0.400 | 63490.2395 | −6.19 | |
| | lens | ASP 6 | 2.892 | D1 | | | |
| | (210) | | | | | | |
| Driven | First lens | ASP 7 | 3.008 | 1.431 | 54401.5597 | 5.02 | 5.169 |
| lens group | (2361c) | ASP 8 | −25.610 | 0.444 | | | |
| (236c) | Second lens | ASP 9 | −18.647 | 0.464 | 614.260 | −169.29 | |
| | (2362c) | ASP 10 | −22.893 | D2 | | | |
| Fixed lens | Third lens | ASP 11 | −10.593 | 0.400 | 54401.5597 | −5.06 | −7.582 |
| group | (2381c) | ASP 12 | 3.788 | 0.467 | | | |
| (238c) | Fourth lens | ASP 13 | 7.417 | 1.456 | 65034.2153 | 15.67 | |
| | (2382c) | ASP 14 | 24.430 | 1.010 | | | |

| Filter (240) | 15 | Infinity | 0.11 | 5168.642 |
|---|---|---|---|---|
| | 16 | Infinity | D3 | |
| Image sensor (250) | 17 | Infinity | 0 | |

In Table 10, surface/plane numbers 0 to 14 may indicate surfaces/planes that are sequentially arranged from the object side to the image side along the light travel direction. The focal length and the composite focal length are values that are measured based on or using a wavelength of 555 nm.

Table 11 below illustrates aspheric coefficients for determining the shape of each of the aspheric surfaces of the lenses according to an embodiment of the present disclosure.

TABLE 11

| Surface | k | A₁ | A₂ | A₃ | A₄ |
|---|---|---|---|---|---|
| ASP 1 | −0.577934 | −5.978687E−05 | −9.950087E−06 | −1.720710E−06 | 1.971245E−07 |
| ASP 5 | −0.991432 | −6.733957E−05 | 5.073045E−04 | −3.554893E−05 | −5.852696E−06 |
| ASP 6 | −0.288019 | −1.708178E−03 | 1.865750E−04 | 8.380601E−05 | −1.522742E−05 |
| ASP 7 | −0.005738 | −1.457129E−03 | −5.017707E−04 | 6.678826E−05 | −7.726076E−06 |
| ASP 8 | 1.000000 | −2.303094E−03 | −7.031699E−04 | −1.768837E−04 | 2.475353E−05 |
| ASP 9 | −1.000000 | −2.245940E−03 | −1.646111E−03 | −3.336098E−05 | −7.314326E−06 |
| ASP 10 | −1.000000 | 3.190824E−03 | −8.199435E−04 | 1.261688E−04 | 2.599821E−06 |
| ASP 11 | −1.000000 | −2.181706E−02 | 3.518451E−03 | −2.044999E−04 | 1.929996E−05 |
| ASP 12 | −0.259984 | −1.501201E−02 | 1.606615E−03 | 6.501765E−05 | −9.283380E−06 |
| ASP 13 | −0.830886 | 6.610105E−04 | −1.625725E−03 | 2.302115E−04 | −7.747323E−06 |
| ASP 14 | −1.000000 | −6.578770E−03 | −2.971535E−04 | 1.536974E−05 | 1.478689E−06 |

Table 12 illustrates examples of distances D1 between the light guide 200c and the driven lens group 236c, distances D2 between the driven lens group 236c and the fixed lens group 238c, and distances D3 between the fixed lens group 238c and the filter 240 according to examples distances DO from the object to the light guide 200c. Units of distances DO to D3 are millimeters (mm).

TABLE 12

| | | | |
|---|---|---|---|
| D0 | Infinity | 1500 | 500 |
| D1 | 0.507 | 0.472 | 0.400 |
| D2 | 0.648 | 0.689 | 0.770 |
| D3 | 0.399 | 0.399 | 0.399 |

Based on the above data, referring to FIG. 12, in an embodiment, the imaging magnification m₁ of the driven lens group 236c may be 0.136, and the imaging magnification m₂ of the fixed lens group 238c may be 1.138. The imaging magnification m₁ of the driven lens group 236c and the imaging magnification m₂ of the fixed lens group 238c may be values (e.g., ratios of image sizes to the object sizes) when the object is at infinity, that is, when the distance DO is at infinity.

Furthermore, in an embodiment, the focal length fp of the reflector 220c may be 10.699 mm, and the composite focal length “f” of the camera module 10c may be 8.8693 mm.

Based on this, the driven lens group 236c and the fixed lens group 238c may satisfy the following first inequality condition:

$$( 10.699 / 8.8693 ) = 1.2063 \leq 2.$$

Accordingly, the apertures of lenses belonging to the driven lens group 236c provided on the image side of the reflector 220c and/or the apertures of lenses belonging to the fixed lens group 238c may be reduced. Furthermore, a smaller camera module 10c may be provided.

Furthermore, based on this, the driven lens group 236c and the fixed lens group 238c may satisfy the following second inequality condition:

$$\vert ( 1 - 0.136 ) \cdot 1.388 \vert = 1.19923 \geq 1.$$

Accordingly, the driven lens group 236c may perform a specific level of a hand-shake correction function with a smaller movement amount. For example, compared to the image sensor shift method, the driven lens group 236c may implement the same performance as that of the hand-shake correction function of the image sensor shift method with a smaller movement amount than the image sensor shift method. Accordingly, a smaller camera module 10c may be provided.

Furthermore, based on this, the driven lens group 236c and the fixed lens group 238c may satisfy the following fourth inequality condition:

$$\vert ( 1 - ( 0.136 ) 2 ) \cdot 1.3882 \vert = 1.89091 \geq 1.$$

Accordingly, the driven lens group 236c may perform a specific level of automatic focusing with a smaller movement amount. For example, compared to an optical system full shift method of performing autofocusing by moving all the lenses embedded in the camera module, the driven lens group 236c may implement the same performance as the autofocusing performance of the optical system full shift method with a smaller movement amount than the movement amounts of the lenses of the optical system full shift method. Accordingly, a smaller camera module 10c may be provided.

According to the embodiments of the present disclosure, the aperture of the first lens group provided on the image side of the light guide may be reduced due to the light guide with a positive refractive power. Accordingly, a smaller camera module may be provided.

Furthermore, according to the embodiments of the present disclosure, the first lens group provided on the image side of the light guide with the positive refractive power is set to be moved in directions that cross the light travel direction, so that the first lens group may perform a hand-shake correction function. Accordingly, a camera module with an improved performance may be provided.

Furthermore, according to the embodiments of the present disclosure, due to the reflector that satisfies the first inequality condition (fp/f)≤2.0, the apertures of the lenses provided on the image side of the reflector may be reduced. Accordingly, a smaller camera module may be provided.

In addition, according to the embodiments of the present disclosure, the light guide may further include a correction lens that is provided between the reflector and the first lens group and is set to correct chromatic aberration. Accordingly, a camera module with an improved performance may be provided.

In addition, according to the embodiments of the present disclosure, the first lens group includes, among the lenses, the first lens that is disposed closest to the light guide, and, among the lenses, the second lens that is disposed closest to the first lens, the first lens has a positive refractive power, and the second lens has a negative refractive power, so that a camera module with an improved correction performance of chromatic aberration may be provided.

Furthermore, according to the embodiments of the present disclosure, the camera module can perform hand-shake correction function through the first lens group and perform autofocusing through the second lens group due to the second lens group that is set to be moved parallel to the light travel direction. Accordingly, a camera module with an improved performance may be provided.

Furthermore, according to the embodiments of the present disclosure, due to the first lens group and the second lens group that satisfy the second inequality condition |(1−m₁)·m₂| ≥1.0 (where m₁ is the imaging magnification of the first lens group and m₂ is the imaging magnification of the second lens group), the camera module may move the first lens group less to perform the hand-shake correction function of a specific level. Accordingly, a camera module with an improved performance and a small size may be provided.

Furthermore, according to the embodiments of the present disclosure, due to the second lens group that satisfies the third inequality condition |1−(m₂)²|≥1.0 (where m₂ is the imaging magnification of the second lens group), the camera module may move the second lens group less to perform automatic focusing of a specific level. Accordingly, a camera module with an improved performance and a small size may be provided.

Furthermore, according to the embodiments of the present disclosure, the first lens group is not only set to be moved in directions that cross the light travel direction, but also to be moved in a direction that is parallel to the light travel direction, so that the first lens group may perform both a hand-shake correction function and an automatic focusing function. In addition, due to the first lens group and the second lens group that satisfy the fourth inequality condition |(1−(m₁)²)·(m₂)²|>1.0, the camera module may move the first lens group less to perform automatic focusing of a specific level. Accordingly, a camera module with an improved performance and a small size may be provided.

Even though different figures illustrate variations of exemplary embodiments and different embodiments disclose different features from each other, these figures and embodiments are not necessarily intended to be mutually exclusive from each other. Rather, features depicted in different figures and/or described above in different embodiments can be combined with other features from other figures/embodiments to result in additional variations of embodiments, when taking the figures and related descriptions of embodiments as a whole into consideration. For example, components and/or features of different embodiments described above can be combined with components and/or features of other embodiments interchangeably or additionally to form additional embodiments unless the context clearly indicates otherwise, and the present disclosure includes the additional embodiments.

The above embodiments are examples of the present disclosure. Modifications of the embodiments which may include design changes are intended to be included in the present disclosure as well as an embodiment described above. In addition, technologies implemented by using the above embodiments may be included in the present disclosure. While the present disclosure has been described with reference to embodiments described above, it will be apparent to those of ordinary skill in the art that various changes and modifications may be made thereto without departing from the spirit and scope of the present disclosure as set forth in the following claims.

What is claimed is:

1. An electronic device comprising:
an image sensor;
a light guide having a positive refractive power, the light guide configured to guide light to the image sensor; and
a lens group located between the light guide and the image sensor,
wherein the lens group includes:
a first lens group including a plurality of lenses; and
a second lens group including at least one lens,
wherein the first lens group is configured to move in directions crossing a light travel direction, and
wherein the second lens group does not move in the directions crossing the light travel direction.

2. The electronic device of claim 1, wherein the light guide is a reflector,
wherein the reflector has a first surface on an object side and a second surface on an image side, and
wherein the first surface of the reflector is convex.

3. The electronic device of claim 2, wherein the second surface of the reflector is convex.

4. The electronic device of claim 2, further comprising:
a camera module including the image sensor, the light guide, and the lens group,
wherein the reflector further includes a reflective surface configured to reflect light input through the first surface toward the second surface, and
wherein the reflector satisfies a first inequality condition of (fp/f)≤2.0, and
wherein fp is a focal length of the reflector, and “f” is a composite focal length of the camera module.

5. The electronic device of claim 2, wherein the light guide further includes a correction lens disposed between the reflector and the first lens group.

6. The electronic device of claim 1, wherein the first lens group includes:
a first lens disposed to be closest to the light guide among the lenses of the first lens group, the first lens having a positive refractive power; and
a second lens disposed to be closest to the first lens among the lenses of the first lens group, the second lens having a negative refractive power.

7. The electronic device of claim 1, wherein the second lens group is configured to move parallel to the light travel direction.

8. The electronic device of claim 7,
wherein the first lens group and the second lens group satisfy a second inequality condition of |(1−m₁)·m₂/≥1.0, and
wherein m₁ is an imaging magnification of the first lens group and m₂ is an imaging magnification of the second lens group.

9. The electronic device of claim 7,
wherein the second lens group satisfies a third inequality condition of |1−(m₂)²|≥1.0, and
wherein m₂ is an imaging magnification of the second lens group.

10. The electronic device of claim 1,
wherein the first lens group is configured to move parallel to the light travel direction, and
wherein the second lens group is fixed.

11. The electronic device of claim 10, wherein the first lens group and the second lens group satisfies a fourth inequality condition of |(1−(m₁)²)·(m₂)²|≥1.0.

12. An electronic device comprising:
an image sensor;
a reflector configured to guide light to the image sensor;
a lens group between the reflector and the image sensor,
wherein the lens group includes:
a first lens group including a plurality of lenses; and
a second lens group including at least one lens,
wherein the first lens group is configured to move in directions crossing a light travel direction, and
wherein the second lens group is configured to move parallel to the light travel direction.

13. The electronic device of claim 12, wherein the reflector has a positive refractive power.

14. The electronic device of claim 13,
wherein the reflector has a first surface on an object side and a second surface on an image side, and
wherein the first surface and the second surface of the reflector are convex.

15. The electronic device of claim 14, further comprising a camera module including the image sensor, the reflector, and the lens group,
wherein the reflector further includes a reflective surface configured to reflect light input through the first surface toward the second surface,
wherein the reflector satisfies a first inequality condition of (fp/f)≤2.0, and
wherein fp is a focal length of the reflector, and “f” is a composite focal length of the camera module.

16. The electronic device of claim 12, wherein the first lens group includes:
a first lens disposed closest to the reflector, among the lenses of the first lens group, and having a positive refractive power; and
a second lens disposed closest to the first lens, among the lenses of the first lens group, and having a negative refractive power.

17. The electronic device of claim 12,
wherein the first lens group and the second lens group satisfy a second inequality condition of |(1−m₁)·m₂|≥1.0, and
wherein m₁ is an imaging magnification of the first lens group and m₂ is an imaging magnification of the second lens group.

18. The electronic device of claim 12,
wherein the second lens group satisfies a third inequality condition of |1−(m₂)²|≥1.0, and
wherein m₂ is an imaging magnification of the second lens group.

19. The electronic device of claim 12, further comprising:
a correction lens disposed between the reflector and the first lens group.

20. An electronic device comprising:
an image sensor;
a light guide having a positive refractive power, the light guide being configured to guide light to the image sensor; and
a lens group located between the light guide and the image sensor,
wherein the lens group includes:
a driven lens group including a plurality of lenses; and
a fixed lens group including at least one lens,
wherein the driven lens group is configured to move in a light travel direction, and directions crossing the light travel direction, and
wherein the fixed lens group is fixed.
